(19) United States
(12) Patent Application Publication
(10) Pub. No.: US 2025/0329811 A1
(43) Pub. Date: Oct. 23, 2025

(54) SELF-HEALING BATTERY PACK

(71) Applicant: Generac Power Systems, Inc., Waukesha, WI (US)

(72) Inventors: David Oteman, Delafield, WI (US); Peter Lex, Waukesha, WI (US); Nicholas Holmstrom, Waukesha, WI (US)

(73) Assignee: Generac Power Systems, Inc., Waukesha, WI (US)

(21) Appl. No.: 19/182,824

(22) Filed: Apr. 18, 2025

Related U.S. Application Data
(60) Provisional application No. 63/637,707, filed on Apr. 23, 2024.

(51) Int. Cl. H01M 10/48; H01M 10/42; H01M 50/204; H01M 50/583

(52) U.S. Cl. CPC H01M 10/488; H01M 10/4207; H01M 10/425; H01M 50/204; H01M 50/583; H01M 2010/4271

(57) ABSTRACT

A self-healing battery pack includes a plurality of battery modules connected in series. When a faulty battery module is detected, an electrical protective device connected in parallel with the faulty battery is caused to operate and thereby bypass the faulty battery module. The self-healing battery pack can additionally report the detection of the faulty battery module. When maintenance is scheduled to replace the faulty battery module, the self-healing battery pack can receive instructions to adjust a state-of-charge of the battery modules to reduce an equalization period.

### CROSS-REFERENCE TO RELATED APPLICATION(S)

This application claims the benefit of and priority to U.S. Application No. 63/637,707, filed on Apr. 23, 2024, titled SELF-SEALING BATTERY PACK, the disclosure of which is hereby incorporated by reference in its entirety.

### BACKGROUND

A battery pack, consisting of an array of battery modules, serves as an energy storage and supply solution for diverse applications. The battery is structured with the integration of one or more battery modules, each housing interconnected battery cells. The battery cells may be connected in series and/or parallel arrangements. The battery modules are also arranged to be connected in series and/or parallel arrangements. The particular interconnection of battery cells and battery modules can be designed to attain specific parameters such as targeted voltage, energy capacity, and related characteristics.

### SUMMARY

In general terms, this disclosure is directed to a battery pack with self-healing capabilities. In some embodiments, and by non-limiting example, the battery pack includes a plurality of battery modules connected in series, wherein each battery module comprises a fuse, a plurality of electrical protective devices, wherein each electrical protective device is connected in parallel with one of the plurality of battery modules, and a battery controller system, operable to monitor the operation of the plurality of battery modules, determine a battery module of the plurality of battery modules is faulty during the monitoring, and cause an associated electrical protective device of the plurality of electrical protective devices connected in parallel with the faulty battery module to operate to bypass the faulty battery module, wherein the associated electrical device operating causes the fuse to operate.

One embodiment of the present disclosure includes, the battery controller system being further operable to send a report of the faulty battery module. In example implementations, the battery controller system is further operable to, in response to sending the report: receive instructions to adjust a state-of-charge of the plurality of battery modules and cause the plurality of battery modules to adjust the state-of-charge according to the instructions. In further example implementations, the battery controller system is further operable to, in response to sending the report: receive instructions to adjust a state-of-charge of the plurality of battery modules by a scheduled time, determine a start time to adjust the state-of-charge of the plurality of battery modules, cause the plurality of battery modules to begin adjusting the state-of-charge at the start time, determine maintenance has been performed, and enable the plurality of battery modules to adjust the state-of-charge according to normal operating conditions. To determine the start time is based on any one of (i) a current state-of-charge of the plurality of battery modules, (ii) a discharge rate of the plurality of battery modules, or (iii) both (i) and (ii).

Another embodiment of the present disclosure includes the battery controller system being further operable to receive instructions to adjust a state-of-charge of the plurality of battery modules and cause the plurality of battery modules to adjust the state-of-charge according to the instructions. Yet another embodiment includes the battery controller system is further operable to: receive instructions to adjust a state-of-charge of the plurality of battery modules by a scheduled time, determine a start time to adjust the state-of-charge of the plurality of battery modules, cause the plurality of battery modules to begin adjusting the state-of-charge at the start time, determine maintenance has been performed, and enable the plurality of battery modules to adjust the state-of-charge according to normal operating conditions. In example implementations, to determine the start time is based on any one of (i) a current state-of-charge of the plurality of battery modules, (ii) a discharge rate of the plurality of battery modules, or (iii) both (i) and (ii).

An additional embodiment of the present disclosure includes the battery controller system is further operable to determine one or more additional battery modules of the plurality of battery modules are faulty, and cause one or more additional associated electrical protective devices of the plurality of electrical protective devices connected in parallel with the one or more additional faulty battery modules to operate to bypass the one or more additional faulty battery modules. A further embodiment includes wherein the battery controller system comprises: one or more sensors operable to collect data related to the operation of the plurality of battery modules, and a battery controller operable to control the self-healing battery pack using the data related to the operation of the plurality of battery modules. In an example implementation, the data related to the operation of the plurality of battery modules comprises any one of: (i) temperature data, (ii) voltage data, (iii) current data, or (iv) any combination of (i)-(iii). Another embodiment of the present disclosure includes wherein the plurality of electrical protective devices are any one of: (i) contactors, (ii) mechanical relays, or (iii) any combination of (i) and (ii).

In another aspect, a method includes monitoring the operation of a plurality of battery modules, determining a battery module of the plurality of battery modules is faulty during the monitoring, and causing an electrical protective device connected in parallel with the faulty battery module to operate to bypass the faulty battery module, wherein the associated electrical device operating causes a fuse connected in series with the faulty battery module to operate. In some embodiments, the method further comprises sending a report of the faulty battery module. In example implementations, the method further comprises in response to sending the report, receiving instructions to adjust a state-of-charge of the plurality of battery modules, and causing the plurality of battery modules to adjust the state-of-charge according to the instructions. In additional example implementations, the method further comprises in response to sending the report, receiving instructions to adjust a state-of-charge of the plurality of battery modules by a scheduled time, determining a start time to adjust the state-of-charge of the plurality of battery modules, causing the plurality of battery modules to begin adjusting the state-of-charge at the start time, determining maintenance has been performed, and enabling the plurality of battery modules to adjust the state-of-charge according to normal operating conditions. Determining the start time can be based on any one of (i) a current state-of-charge of the plurality of battery modules, (ii) a discharge rate of the plurality of battery modules, or (iii) both (i) and (ii).

In some embodiments, the method further comprises receiving instructions to adjust a state-of-charge of the plurality of battery modules and causing the plurality of battery modules to adjust the state-of-charge according to the instructions. In further embodiments, the method further comprises receiving instructions to adjust a state-of-charge of the plurality of battery modules by a scheduled time, determining a start time to adjust the state-of-charge of the plurality of battery modules, causing the plurality of battery modules to begin adjusting the state-of-charge at the start time, determining maintenance has been performed, and enabling the plurality of battery modules to adjust the state-of-charge according to normal operating conditions. Determining the start time can be based on any one of (i) a current state-of-charge of the plurality of battery modules, (ii) a discharge rate of the plurality of battery modules, or (iii) both (i) and (ii).

In further embodiments, the method further comprises determining one or more additional battery modules of the plurality of battery modules are faulty and causing one or more additional electrical protective devices connected in parallel with the one or more additional faulty battery modules to operate to bypass the one or more additional faulty battery modules. Determining the battery module is faulty can be based on any one of: (i) temperature data, (ii) voltage data, (iii) current data, or (iv) any combination of (i)-(iii). In some embodiments, the electrical protective device is any one of (i) a contactor, or (ii) a mechanical relay.

In yet another aspect, a method comprises receiving instructions to adjust a state-of-charge of a plurality of battery modules by a scheduled time, determining a start time to adjust the state-of-charge of the plurality of battery modules, causing the plurality of battery modules to begin adjusting the state-of-charge at the start time, determining maintenance has been performed, and enabling the plurality of battery modules to adjust the state-of-charge according to normal operating conditions. Determining the start time can be based on any one of (i) a current state-of-charge of the plurality of battery modules, (ii) a discharge rate of the plurality of battery modules, or (iii) both (i) and (ii). In example embodiments, the method further comprises monitoring the operation of the plurality of battery modules, determining a battery module of the plurality of battery modules is faulty during the monitoring, and causing an electrical protective device connected in parallel with the faulty battery module to operate to bypass the faulty battery module. In example implementations, the method further comprises sending a report of the faulty battery module, wherein receiving the instructions is in response to sending the report.

### BRIEF DESCRIPTION OF THE DRAWINGS

FIG. 1 is a block diagram illustrating an example operating environment for a self-healing battery pack.

FIG. 2 is a block diagram illustrating an example battery module circuit of self-healing battery packs.

FIG. 3A is a circuit diagram illustrating an example healthy self-healing battery pack.

FIG. 3B is a circuit diagram illustrating an example healed self-healing battery pack.

FIG. 4 is a flowchart illustrating an example method of a battery pack self-healing.

FIG. 5 is a flowchart illustrating an example method for automatically adjusting battery modules for installation and maintenance.

### DETAILED DESCRIPTION

Various embodiments will be described in detail with reference to the drawings, wherein like reference numerals represent like parts and assemblies throughout the embodiments. Reference to various embodiments does not limit the scope of the claims attached hereto. Additionally, any examples set forth in this specification are not intended to be limiting and merely set forth some of the many possible embodiments for the appended claims.

A self-healing battery pack, methods for enabling a battery pack to self-heal, and methods for remotely adjusting the state-of-charge of battery modules are described herein. The self-healing process can include identifying a broken or otherwise incorrectly operating battery module and bypassing the faulty battery module to enable the battery pack to continue operating at a reduced rate rather than completely disabling the battery pack due to the faulty battery module. Current battery designs may require the entire system to be shut down until a technician bypasses or replaces the faulty battery module, but the self-healing battery can automatically bypass the faulty battery module to continue operation.

Current battery designs require a substantial period to equalize the state-of-charge of the battery modules in a battery pack after a faulty battery module is replaced with a replacement battery module. For example, if currently operating battery modules have a ninety percent of maximum capacity state-of-charge and the replacement battery module has a thirty percent of maximum capacity state-of-charge, the battery pack may be completely unavailable for use or the operation may be limited (e.g., operating at twenty percent of rated energy during the equalization process). Thus, to avoid or reduce the equalization period, the state-of-charge of battery modules can be remotely adjusted to prepare the battery pack for maintenance (e.g., replacing the faulty battery module). For example, the state-of-charge for a replacement battery module may be set to thirty percent of maximum capacity for transport and installation, and the installed battery modules can therefore be instructed to have a state-of-charge of thirty percent of maximum capacity at a scheduled time when the replacement battery module will be installed, resulting in no equalization period or a shorter period for equalizing the states-of-charge of the battery modules.

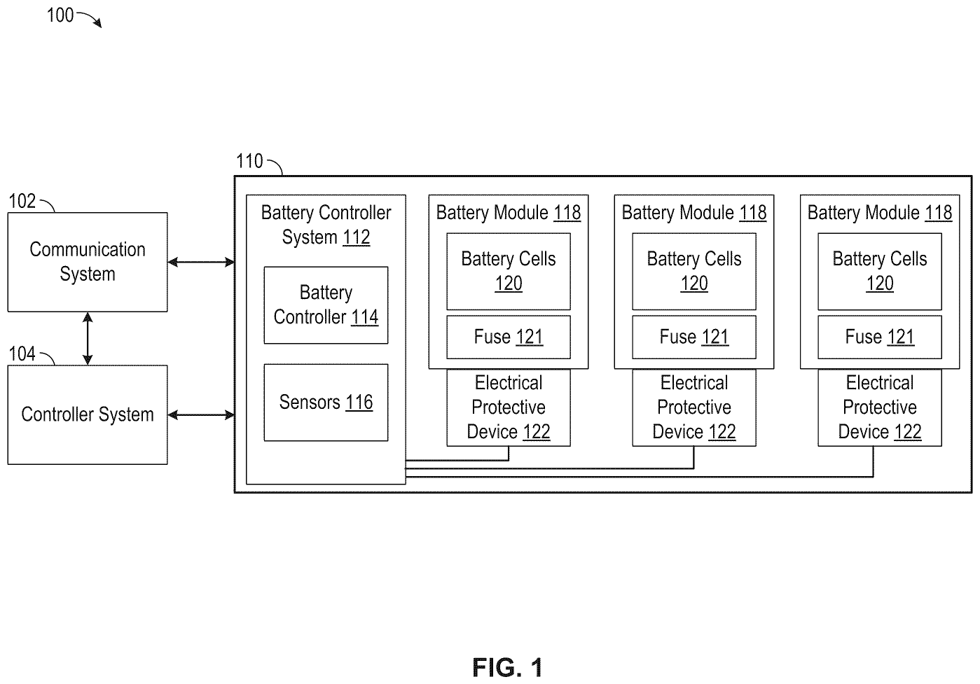

FIG. 1 is a block diagram illustrating an operating environment 100 for a self-healing battery pack. The operating environment 100 includes a communication system 102, a controller system 104, and a self-healing battery pack 110. The communication system 102 may enable the controller system 104 and the self-healing battery pack 110 to send and/or receive information to and from other devices, such as a device associated with an electric utility, a device associated with a user of the self-healing battery pack 110, and/or the entity associated with maintaining the self-healing battery pack 110. The controller system 104 may control the self-healing battery pack 110 such as by communicating with the self-healing battery pack 110, monitoring the self-healing battery pack 110, sending instructions to self-healing battery pack 110, and the like.

The self-healing battery pack 110 includes a battery controller system 112 that includes a battery controller 114 and sensors 116. The self-healing battery pack 110 also includes one or more battery modules 118, each including one or more battery cells 120 and a fuse 121, each connected in parallel with an electrical protective device 122. Three battery modules 118 are illustrated in this example, but there may a different amount of battery modules 118 in further examples.

The electrical protective devices 122 may be devices that identify and/or address electrical problems and perform corrective action, such as relays, switches, circuit breakers, and/or the like. Particularly, the electrical protective devices 122 and/or the battery controller system 112 may identify a faulty battery module 118, and the electrical protective device 122 associated with the identified faulty battery module 118 may operate to electrically isolate or otherwise bypass the faulty battery module 118. When the electrical protective device 122 operates, the fuse 121 associated with the faulty battery module 118 may be caused to operate and break the circuit path of the faulty battery module 118. For example, the new electrical path or short the electrical protective device 122 creates when it operates causes the fuse 121 to operate (e.g., a metal wire melts when too much current flows through the fuse 121). In some embodiments, the electrical protective devices 122 are electronically controlled switches, such as a contactor or a mechanical relay, which are in the open position (i.e., broken circuit) when no power is supplied. Therefore, the electrical protective devices 122 will consume no power or minimal power when the battery modules 118 are operating normally. When one or more of the battery modules 118 is faulty (i.e., the associated battery cells 120 are operating incorrectly or dead), power can be supplied to the associated electrical protective device 122 so the electrical protective device 122 shifts to the closed position (i.e., completed circuit) and causes the faulty battery module 118 to be bypassed.

Multiple battery modules 118 are connected in series in the self-healing battery pack 110. In some examples, there are multiple groups of battery modules 118 connected in series. The self-healing battery pack 110 can be used for residential and commercial applications. For example, the self-healing battery pack 110 can be sized, installed, and operated as an energy storage and backup system at a residence or can be sized, installed, and operated as an energy storage and backup system at a utility substation. For example, the self-healing battery pack 110 may have four to six battery modules 118 connected in series when the self-healing battery pack 110 is used at a residence, and the self-healing battery pack 110 may have up to sixteen battery modules 118 connected in series when the self-healing battery pack 110 is used at a substation. The self-healing battery pack 110 can include any number of battery modules 118 connected in series in other examples. The self-healing battery pack 110 can include different configurations and/or types of battery modules 118 so the self-healing battery pack 110 has desired properties for the use of the self-healing battery pack 110 (e.g., higher voltage and storage capacity for a self-healing battery pack 110 used at a substation compared to a self-healing battery pack 110 used at a residence).

The battery controller 114 can control the operation of the components of the self-healing battery pack 110. The sensors 116 can collect data the battery controller 114 and/or the controller system 104 can use to determine how the self-healing battery pack 110 should operate. For example, the sensors 116 may collect temperature data, voltage data, current data, and/or other data that may indicate a battery module fault. The battery controller 114 may use the data the sensors 116 collect to determine whether a battery module 118 is faulty or otherwise operating incorrectly. The battery controller 114 may cause the electrical protective device 122 connected in parallel to the faulty battery module 118 to operate, additionally causing the associated fuse 121 to operate. Thus, the faulty battery module 118 will be bypassed, enabling the self-healing battery pack 110 to continue operation. In some examples, the controller system 104 controls the operation of the components of the self-healing battery pack 110. In other examples, individual control modules (e.g., a control module for each battery module 118) control the components of the self-healing battery pack 110.

In some examples, the battery controller 114 and/or the controller system 104 may send out a notification that one or more battery modules 118 need to be replaced or have some type of maintenance performed before the bypass will be removed. Once the maintenance is scheduled, the communication system 102 may receive instructions to cause the self-healing battery pack 110 to adjust the states-of-charge of the battery modules 118 by a scheduled time. The controller system 104 and/or the battery controller 114 can cause the battery modules 118 to adjust the state-of-charge by the scheduled time based on the received instructions. The battery modules 118 may therefore be at a desired state-of-charge when maintenance is scheduled to occur. When a technician comes to replace a battery module 118, the technician may add a new battery module 118, including new battery cells 120 and a new fuse 121. In some examples, the associated electrical protective device 122 and/or sensors 116 may also be replaced.

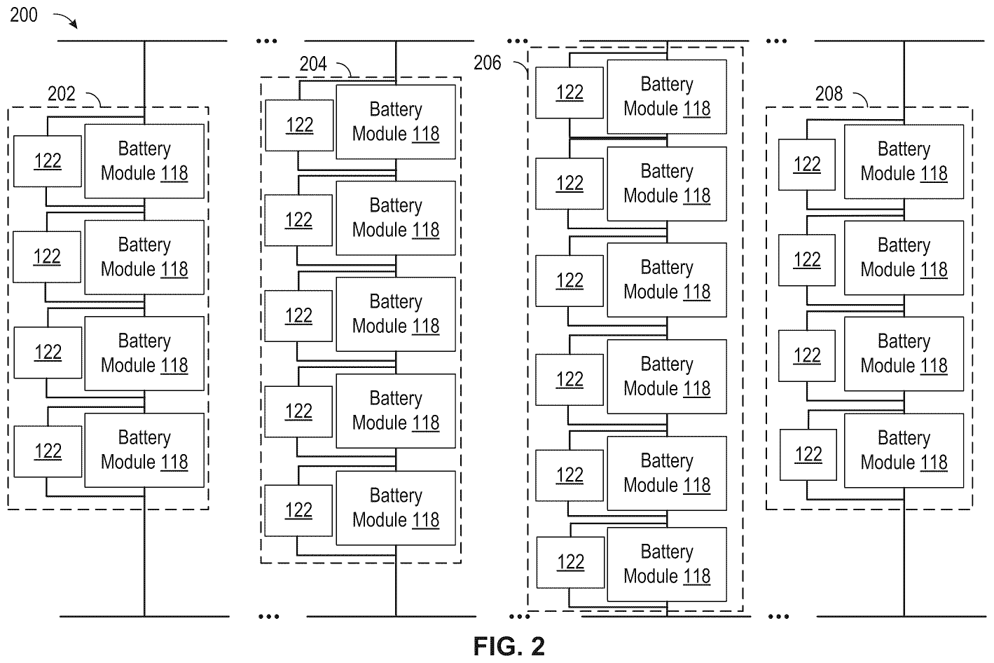

FIG. 2 is a block diagram illustrating a battery module circuit 200 of self-healing battery packs. The battery module circuit 200 includes a first group of battery modules 202, a second group of battery modules 204, a third group of battery modules 206, and a fourth group of battery modules 208. The first group of battery modules 202, the second group of battery modules 204, the third group of battery modules 206, and the fourth group of battery modules 208 are each a group of battery modules 118 connected in series with an electrical protective device 122 connected to a respective battery module 118 in parallel. Because the battery modules 118 are connected in series, a faulty battery module 118 may compromise the operation of the other battery modules 118 unless the electrical protective device 122 and the fuse 121 associated with the faulty battery module 118 operate to bypass the faulty battery module 118. Multiple faulty battery modules 118 can be bypassed to allow the continued operation of healthy battery modules 118.

The first group of battery modules 202, the second group of battery modules 204, the third group of battery modules 206, and the fourth group of battery modules 208 may be part of a single self-healing battery pack 110 (e.g., connected in parallel) and/or may each be part of a different self-healing battery pack 110. The first group of battery modules 202, the second group of battery modules 204, the third group of battery modules 206, and the fourth group of battery modules 208 may therefore independently store and/or provide power.

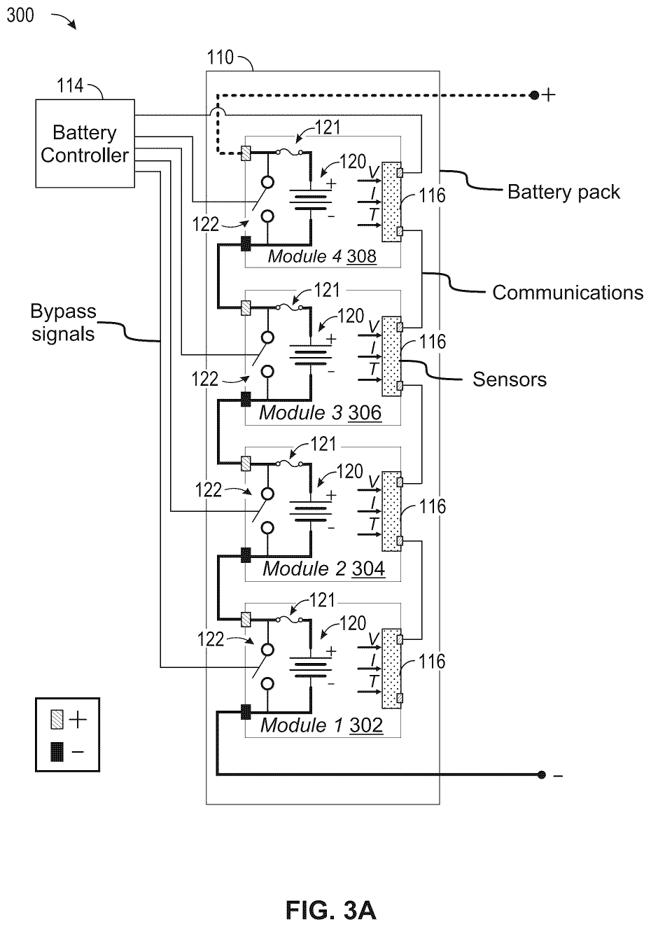

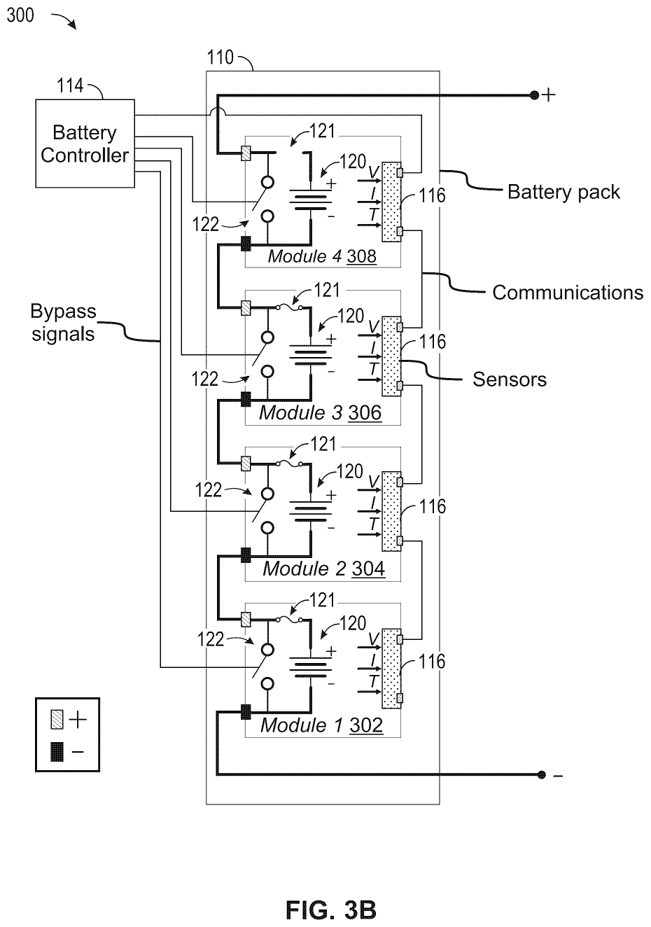

FIG. 3A is circuit diagram illustrating a healthy self-healing battery pack 300. The healthy self-healing battery pack 300 includes four battery modules 118, a first battery module 302, a second battery module 304, a third battery module 306, and a fourth battery module 308. The sensors 116 are attached or otherwise monitoring the first battery module 302, the second battery module 304, the third battery module 306, and the fourth battery module 308 so the battery controller 114 can identify if any of the first battery module 302, the second battery module 304, the third battery module 306, and the fourth battery module 308 are faulty. In this illustrated example, the battery controller 114 is shown as separate from the self-healing battery pack 110, but the battery controller 114 may be part of the self-healing battery pack 110 in other examples. Additionally in this illustrated example, the electrical protective devices 122 are integrated into the first battery module 302, the second battery module 304, the third battery module 306, and the fourth battery module 308. Thus, in some examples, when a battery module 118 is replaced, the associated electrical protective device 122, fuse 121, and/or sensors 116 may also be replaced with the battery cells 120. In other examples, only the battery cells 120 and/or fuse 121 will be replaced.

The electrical protective devices 122 of the healthy self-healing battery pack 300 are all open or otherwise enabling the associated battery module 118 to not be bypassed because the first battery module 302, the second battery module 304, the third battery module 306, and the fourth battery module 308 are all healthy. The sensors 116 and the battery controller 114 may monitor the operation of the first battery module 302, the second battery module 304, the third battery module 306, and the fourth battery module 308 to determine if any of the battery modules 118 start to operate incorrectly or are otherwise faulty.

FIG. 3B is circuit diagram illustrating the example of a healed battery pack 320. For example, the battery controller 114 and/or the sensors 116 of the healed battery pack 320 may have monitored the operation of the first battery module 302, the second battery module 304, the third battery module 306, and the fourth battery module 308, and determined the fourth battery module 308 was faulty. The battery controller 114 caused the electrical protective device 122 in parallel with the fourth battery module 308 to operate, additionally causing the fuse 121 in series to operate. Thus, the circuit path to the faulty battery cells 120 of the fourth battery module 308 is opened or otherwise bypassed by the open fuse 121, and the circuit path via the electrical protective device 122 is closed or otherwise connected.

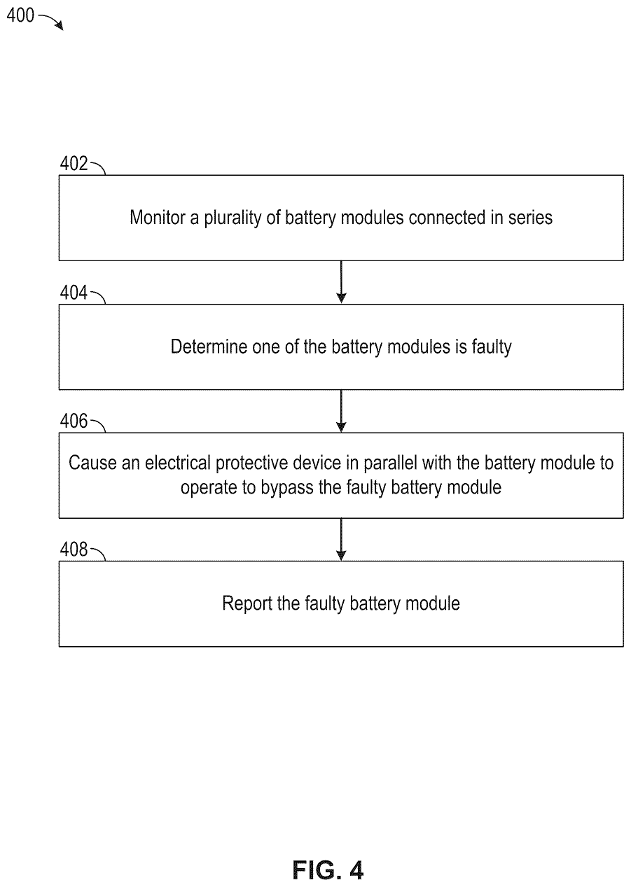

FIG. 4 is a flowchart illustrating a method 400 of a battery pack self-healing. The method 400 starts at operation 402, and a plurality of battery modules connected in series are monitored. For example, the battery controller 114 and the sensors 116 monitor the operation of the battery modules 118. The battery controller 114 may use data the sensors 116 collect to determine whether the battery modules 118 are operating correctly. For example, a higher than normal operating temperature, an over voltage, an over current, and/or the like may indicate that a battery module 118 is not operating correctly.

In operation 404, one of the battery modules is determined to be faulty. For example, the battery controller 114 determines one of the battery modules 118 is faulty based on the data the sensors 116 collect. Multiple battery modules 118 may be determined to be faulty in some examples.

In operation 406, the electrical protective device in parallel with the battery module is caused to operate to bypass the faulty battery module. For example, the battery controller 114 causes the electrical protective device 122 in parallel with the faulty battery module 118 to operate (e.g., close). The fuse 121 will operate in response, thereby bypassing the faulty battery module 118 and enabling a circuit path via the path the electrical protective device 122 creates by operating.

In operation 408, the faulty battery module is reported. For example, the battery controller 114 sends a communication, via the communication system 102, indicating that the faulty battery module 118 needs repair or replacement to a device associated with the entity that maintains the self-healing battery pack 110.

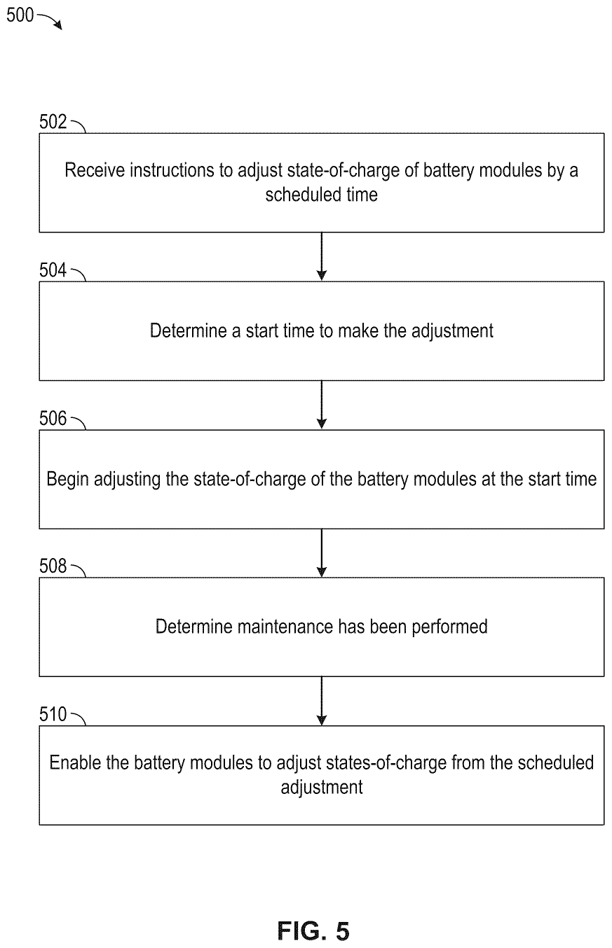

FIG. 5 is a flowchart illustrating an example method 500 for automatically adjusting battery modules for installation and maintenance. Method 500 starts at operation 502, and instructions are received to adjust states-of-charge of battery modules by a scheduled time. For example, the battery controller 114 may receive instructions via the communication system 102 to adjust the states-of-charge of the battery modules 118 by a scheduled time. In certain embodiments, the scheduled time is the period a technician is scheduled to perform maintenance (e.g., replacing a faulty battery module 118) on the self-healing battery pack 110. The instructions received in operation 502 may be in response to reporting the faulty battery module 118 in operation 408 of the method 400 in some examples. In some embodiments, the instructions are for the self-healing battery pack 110 to make adjustments so the state-of charge of the healthy battery modules 118 will be the same state-of-charge as a replacement battery module 118.

In operation 504, a start time to make the adjustment is determined. For example, the battery controller 114 determines the start time based on the amount of energy the battery modules 118 must discharge, the discharge rate of the battery modules 118, and the like. The battery controller 114 may therefore determine the start time so the healthy battery modules 118 have reached the state-of-charge instructed in operation 502 by the scheduled time.

In operation 506, the adjusting the states-of-charge of the battery modules begins at the start time. For example, the battery controller 114 instructs the healthy battery modules 118 to begin adjusting the state-of-charge at the start time. In operation 508, maintenance is determined to have been performed. For example, the battery controller 114 determines or is otherwise notified that maintenance has been performed. The battery modules 118 therefore can begin adjusting the states-of-charge for normal operation of the self-healing battery pack 110. In operation 510, the battery modules 118 are enabled, by the battery controller 114 for example, to adjust states-of-charge from the scheduled adjustment received in operation 502.

Referring to the above processes generally, it is noted that certain aspects may be performed in different orders. Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

The example embodiments described herein may be implemented using hardware, software, or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more memory cards (e.g., flash memory) for program and data storage, and a random-access memory, for temporary data and program instruction storage. From a software standpoint, a CPU typically includes software resident on a storage media (e.g., a memory card), which, when executed, directs the CPU in performing transmission and reception functions. The CPU software may run on an operating system stored on the storage media, such as, for example, UNIX or Windows, iOS, Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software embodiments of the example embodiments presented herein may be provided as a computer program product, or software, which may include an article of manufacture on a machine accessible or non-transitory computer-readable medium (i.e., also referred to as “machine readable medium”) having instructions. The instructions on the machine accessible or machine-readable medium may be used to program a computer system or other electronic device. The machine-readable medium may include, but is not limited to, optical disks, CD-ROMs, and magneto-optical disks or other type of media/machine¬readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments have been described above, it should be understood that they have been presented by way of example, and not limitation. It will be apparent to persons skilled in the relevant art(s) that various changes in form and detail can be made therein. Thus, the present invention should not be limited by any of the above-described example embodiments but should be defined only in accordance with the following claims and their equivalents.

What is claimed is:

1. A self-healing battery pack comprising:
a plurality of battery modules connected in series, wherein each battery module comprises a fuse;
a plurality of electrical protective devices, wherein each electrical protective device is connected in parallel with one of the plurality of battery modules; and
a battery controller system, operable to:
monitor the operation of the plurality of battery modules,
determine a battery module of the plurality of battery modules is faulty during the monitoring, and
cause an associated electrical protective device of the plurality of electrical protective devices connected in parallel with the faulty battery module to operate to bypass the faulty battery module, wherein the associated electrical protective device operating causes the fuse to operate.

2. The self-healing battery pack of claim 1, wherein the battery controller system is further operable to send a report of the faulty battery module.

3. The self-healing battery pack of claim 2, wherein the battery controller system is further operable to:
in response to sending the report, receive instructions to adjust a state-of-charge of the plurality of battery modules; and
cause the plurality of battery modules to adjust the state-of-charge according to the instructions.

4. The self-healing battery pack of claim 2, wherein the battery controller system is further operable to:
in response to sending the report, receive instructions to adjust a state-of-charge of the plurality of battery modules by a scheduled time;
determine a start time to adjust the state-of-charge of the plurality of battery modules;
cause the plurality of battery modules to begin adjusting the state-of-charge at the start time;
determine maintenance has been performed; and
enable the plurality of battery modules to adjust the state-of-charge according to normal operating conditions.

5. The self-healing battery pack of claim 4, wherein to determine the start time is based on any one of (i) a current state-of-charge of the plurality of battery modules, (ii) a discharge rate of the plurality of battery modules, or (iii) both (i) and (ii).

6. The self-healing battery pack of claim 1, wherein the battery controller system is further operable to:
receive instructions to adjust a state-of-charge of the plurality of battery modules; and
cause the plurality of battery modules to adjust the state-of-charge according to the instructions.

7. The self-healing battery pack of claim 1, wherein the battery controller system is further operable to:
receive instructions to adjust a state-of-charge of the plurality of battery modules by a scheduled time;
determine a start time to adjust the state-of-charge of the plurality of battery modules;
cause the plurality of battery modules to begin adjusting the state-of-charge at the start time;
determine maintenance has been performed; and
enable the plurality of battery modules to adjust the state-of-charge according to normal operating conditions.

8. The self-healing battery pack of claim 1, wherein the battery controller system is further operable to:
determine one or more additional battery modules of the plurality of battery modules are faulty; and
cause one or more additional associated electrical protective devices of the plurality of electrical protective devices connected in parallel with the one or more additional faulty battery modules to operate to bypass the one or more additional faulty battery modules.

9. The self-healing battery pack of claim 1, wherein the battery controller system comprises:
one or more sensors operable to collect data related to the operation of the plurality of battery modules; and
a battery controller operable to control the self-healing battery pack using the data related to the operation of the plurality of battery modules.

10. The self-healing battery pack of claim 9, wherein the data related to the operation of the plurality of battery modules comprises any one of: (i) temperature data, (ii) voltage data, (iii) current data, or (iv) any combination of (i)-(iii).

11. The self-healing battery pack of claim 1, wherein the plurality of electrical protective devices are any one of: (i) contactors, (ii) mechanical relays, or (iii) any combination of (i) and (ii).

12. A method comprising:
monitoring the operation of a plurality of battery modules;
determining a battery module of the plurality of battery modules is faulty during the monitoring; and
causing an electrical protective device connected in parallel with the faulty battery module to operate to bypass the faulty battery module, wherein the electrical protective device operating causes a fuse connected in series with the faulty battery module to operate.

13. The method of claim 12, further comprising:
sending a report of the faulty battery module.

14. The method of claim 13, further comprising:
in response to sending the report, receiving instructions to adjust a state-of-charge of the plurality of battery modules; and
causing the plurality of battery modules to adjust the state-of-charge according to the instructions.

15. The method of claim 13, further comprising:
in response to sending the report, receiving instructions to adjust a state-of-charge of the plurality of battery modules by a scheduled time;
determining a start time to adjust the state-of-charge of the plurality of battery modules;
causing the plurality of battery modules to begin adjusting the state-of-charge at the start time;
determining maintenance has been performed; and
enabling the plurality of battery modules to adjust the state-of-charge according to normal operating conditions.

16. The method of claim 15, wherein determining the start time is based on any one of (i) a current state-of-charge of the plurality of battery modules, (ii) a discharge rate of the plurality of battery modules, or (iii) both (i) and (ii).

17. The method of claim 12, further comprising:
receiving instructions to adjust a state-of-charge of the plurality of battery modules; and
causing the plurality of battery modules to adjust the state-of-charge according to the instructions.

18. The method of claim 12, further comprising:
receiving instructions to adjust a state-of-charge of the plurality of battery modules by a scheduled time;
determining a start time to adjust the state-of-charge of the plurality of battery modules;
causing the plurality of battery modules to begin adjusting the state-of-charge at the start time;
determining maintenance has been performed; and
enabling the plurality of battery modules to adjust the state-of-charge according to normal operating conditions.

19. The method of claim 18, wherein determining the start time is based on any one of (i) a current state-of-charge of the plurality of battery modules, (ii) a discharge rate of the plurality of battery modules, or (iii) both (i) and (ii).

20. The method of claim 12, further comprising:
determining one or more additional battery modules of the plurality of battery modules are faulty; and
causing one or more additional electrical protective devices connected in parallel with the one or more additional faulty battery modules to operate to bypass the one or more additional faulty battery modules.
